(19) United States
(12) Patent Application Publication
(10) Pub. No.: US 2016/0221220 A1
(43) Pub. Date: Aug. 4, 2016

(54) VOLUMETRIC MIXER WITH MONITORING SYSTEM AND CONTROL SYSTEM

(71) Applicant: OMEGA MIXERS, L.L.C., Ankeny, IA (US)

(72) Inventor: Daniel Paige, Ankeny, IA (US)

(21) Appl. No.: 15/012,676

(22) Filed: Feb. 1, 2016

Related U.S. Application Data
(60) Provisional application No. 62/110,664, filed on Feb. 2, 2015.

(51) Int. Cl. B28C 5/42; B28C 5/00

(52) U.S. Cl. CPC B28C 5/422; B28C 5/4234; B28C 5/003

(57) ABSTRACT

A volumetric concrete mixer includes a monitoring and control system that assures a uniform amount of cement per unit of aggregate. A processor is in communication to receive an input of a weight of a cement bin from a cement bin load cell and in communication to receive an input of a number of rotations of a conveyor from an aggregate sensor. The processor is adapted to determine a rate of change of weight of the cement bin over a set number of rotations of the conveyor, and to instruct the cement dispenser to adjust the cement dispenser speed to maintain a constant rate of cement being dispensed from the dispenser bin to the mixing area per the set number of rotations of the conveyor.

### CROSS REFERENCE TO RELATED APPLICATIONS

This application claims priority under 35 U.S.C. §119 to provisional application U.S. Ser. No. 62/110,664 filed Feb. 2, 2015, herein incorporated by reference in its entirety.

### FIELD OF THE INVENTION

This invention relates generally to concrete mixers, and more particularly to concrete mixers that make concrete on a volumetric basis, rather than on a batch basis.

### BACKGROUND OF THE INVENTION

Concrete is an important and well-known structural material. It is used primarily as a paving material, but also to provide foundations, and other structural components. Concrete is a mixture of cement and aggregates. The most common cement is Portland cement, but other binding materials are also well-known and commonly used. The aggregates include rocks, sand, and other similar materials of varying sizes. The dry cement is mixed with water and the aggregate to form the concrete. Additionally, various other chemicals and admixtures may be included in the mixture depending upon the intended use of the concrete, as well as environmental factors such as temperature and relative humidity at the time the concrete is being mixed and poured.

Traditionally, concrete has been mixed in relatively large stationary mixing plants, and then loaded on to a truck with a rotating barrel to be transported to a job site. The rotating barrel keeps the concrete mixer flowable and mixed, until the truck can arrive at the job site.

Recently, mobile concrete mixing units have been developed that mix and dispense the concrete at the job site as it is needed. This is advantageous as it eliminates the need for transporting the wet concrete mixture. Additionally, it takes a lot of the guesswork out of trying to get the proper mixture to match the conditions at the job site. Moreover, many concrete mixtures begin deteriorating after they are mixed, and are subject to spoilage before they reach the job site. Some of these mobile concrete mixtures are of a volumetric nature, as opposed to a batch nature. That means that the stream of concrete leaving the mixer should be uniform at each time the mixture is being dispensed. In other words, the ratio of components in any given volume of the mixture should be uniform. In a batch system it is only necessary to assure that the ratio of ingredients in the entire batch matches a set standard.

To assure that the concrete being mixed maintains a uniform composition, it is common practice to collect a “count” or a set number of counts (typically 100 counts) of concrete at set intervals during a mixing and pouring process to verify that the amount of cement within each count remains at the desired range. A “count” is the amount of aggregate dispensed each time the aggregate dispensing belt completes one revolution. The ratio of cement within each count must be uniform to within a set standard range, commonly within 1% of the desired amount.

In the past it has been difficult to assure that the amount of cement in the mixture remains constant per count. Standard practice has been to adjust the rate at which the cement is dispensed in response to the results of the periodic tests. This is not ideal because it means there is lag between the ratio getting out of the desired range and correcting the rate of cement being dispensed. Others have attempted to measure the actual amount of cement that has been dispensed over a period of time by weighing the components as they are dispensed to determine whether they are remaining in the proper ratios. However, it can be difficult to accurately measure weights in mobile units that can be used on a variety of sloped surfaces that can affect the accuracy of the weight measurements. Furthermore, a simplified system that maintains the cement to count ratio using the rate of change of weight of the cement itself has not been presented.

The present invention is directed to overcoming challenges associated with controlling volumetric concrete mixers to assure that the concrete being dispensed is uniform and meets required standards.

### SUMMARY OF THE INVENTION

It is an object of the present invention to provide a volumetric concrete mixer that is automatically calibrated volumetrically.

It is an object of the present invention to provide a volumetric concrete mixer that continually monitors mixer status and adjusts cement output to maintain desired mixture design parameters.

It is an object of the present invention to automatically adjust the rate at which cement is added to a concrete mixture during a volumetric mixing operation in order to maintain a uniform ratio of cement in the mixture at all times of a pour.

It is an object of the present invention to use the rate of change of the weight of a cement bin to automatically adjust the rate at which cement is added to a concrete mixture during a volumetric mixing operation in order to maintain a uniform ratio of cement in the mixture on a per count basis at all times of a pour.

It is an object of the present invention to provide a volumetric concrete mixer that has improved control of the uniformity of the amount of cement added to the concrete mixture at all times of a pour.

It is another object of the present invention to provide a method of volumetrically mixing concrete in a way that maintains a desired ratio of cement at all times of a pour without operator intervention.

According to one embodiment, the present invention is an electronic system that continually monitors mixer status and adjusts cement output to maintain electronically stored mixture design parameters. An electronic controller, setup through operator controls, monitors the output of the cement through a decumulating system along with the conveyor output. The controller increases or decreases the cement output to maintain the desired cement output or ratio needed for the conveyor output setting. This provides a correction for differing outputs of cement due to material issues, material density or equipment output fluctuations. The decumulating system is a relative-weight-based system that provides the controller with information on the output of cement.

According to one embodiment, the present invention is a volumetric concrete mixer that has a support frame and an aggregate bin supported by the support frame. A conveyor is below the aggregate bin for transporting aggregate to a mixing area. An aggregate sensor counts rotations of the conveyor. A cement bin is also supported by the support frame. A cement bin load cell is located between the cement bin and the support frame for measuring a weight of the cement bin. A cement dispenser is operably connected to the cement bin for dispensing cement from the cement bin to the mixing area at a cement dispenser speed. A water dispenser dispenses water from a water supply to the mixing area. A processor is in communication to receive an input of the weight of the cement bin from the cement bin load cell and in communication to receive an input of a number of rotations of the conveyor from the aggregate sensor. The processor is adapted to determine a rate of change of weight of the cement bin over a set number of rotations of the conveyor. The processor is further adapted to instruct the cement dispenser to adjust the cement dispenser speed to maintain a constant rate of cement being dispensed from the dispenser bin to the mixing area per the set number of rotations of the conveyor.

According to another embodiment, the present invention is a method of dispensing concrete on a volumetric basis by providing a volumetric concrete mixer that includes: a support frame; an aggregate bin supported by the support frame; a conveyor below the aggregate bin for transporting aggregate to a mixing area; a cement bin; a cement dispenser for dispensing cement from the cement bin to the mixing area, the cement dispenser including a dispensing element that moves at a controllable speed; a water supply; and a water dispenser for dispensing water from the water supply to the mixing area. Aggregate is conveyed to the mixing area with the conveyor while counting rotations of the conveyor. Cement from the cement bin is conveyed to the mixing area by running the dispensing element of the cement dispenser at an initial rate. Water is dispensed to the mixing area. A weight of the cement bin is periodically measured to determine a rate of change of the weight of the cement bin. The rate of the dispensing element of the cement dispenser is adjusted from the initial rate to a subsequent rate to maintain a constant rate of cement being dispensed from the dispenser bin to the mixing area per the set number of rotations of the conveyor.

### BRIEF DESCRIPTION OF THE DRAWINGS

FIG. 1 is a schematic of a volumetric mixing system according to one embodiment of the present invention.

FIG. 2 is a side elevation view of a mobile concrete mixing unit according to one embodiment of the present invention provided on a truck.

FIG. 3 is a schematic of the volumetric mixing system of the concrete mixing unit of FIG. 2.

### DETAILED DESCRIPTION OF THE PREFERRED EMBODIMENTS

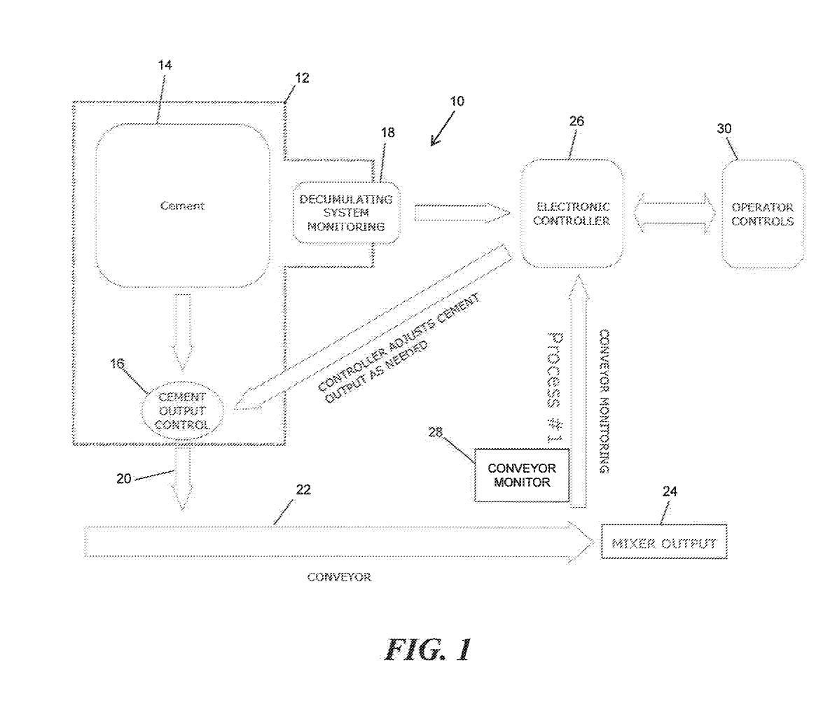

FIG. 1 shows a schematic of a volumetric mixing system 10 according to one embodiment of the present invention. The system 10 includes a cement dispensing apparatus 12 that includes a cement supply 14, a cement output control 16, and a cement decumulating monitoring system 18. The cement dispensing apparatus 12 provides an output 20 of cement to a conveyor 22. The conveyor 22, commonly a conveyor belt, will convey the cement, and generally also aggregate, to a mixer output 24. A controller 26 receives a signal from the cement decumulating monitoring system 18 that the controller 26 uses to determine the rate at which the cement is decumulating (i.e., being dispensed) from the cement supply 14. A conveyor monitor 28 provides a signal to the controller 26 that indicates the rate at which the conveyor is moving (e.g., rpms). Operator controls 30 are also associated with the controller 26 to permit a user to provide input into the controller and receive output indicating the status.

The cement supply 14 may be a hopper or other container containing dry cement mix. The hopper may have an aperture or other controllable opening that permits the dry cement mix to drop onto the conveyor 22. The cement output control 16 may be an adjustable auger. The rate of cement being dispensed can be varied by varying the speed at which the auger is rotated. Those of skill in the art will be aware of other suitable mechanisms that can adjust the rate at which the cement is supplied to the mixer output, and such mechanisms are meant to be included within the meaning of the terms cement output control.

The decumulating monitoring system 18 should provide a signal to the controller 26 that indicates the rate at which cement is decumulating from the cement dispensing apparatus 12. The decumulating monitoring system 18 can include any of a number of mechanisms for measuring the rate at which the cement is being dispensed from the cement dispensing apparatus 12. For example, and without limiting the possibilities, the decumulating system may be based on weight, radar readings, sonar readings, height gauges, electronic measurement systems, X-ray systems, pycnometric readings, and laser sensors.

The controller 26 may be a computer, such as a programmable logic controller (PLC). The controller 26 may include one or more input devices such as a keyboard or touch screen. The controller 26 may also include one or more output devices, such as a monitor screen, indicator lights, and audio speakers. The controller 26 should be adapted to receive signals from the decumulating monitoring system 18 as well as from the conveyor monitor 28. The signals may be electrical signals carried through wiring, or may be wireless signals such as infrared, wifi, Bluetooth, radio, and the like. The signals from the decumulating monitoring system 18 may directly indicate the rate at which the cement is decumulating, or may provide the information that the controller 26 needs to calculate the decumulation rate. Similarly, the signal from the conveyor monitor 28 may directly provide the rate at which the conveyor 22 is moving in terms of rpms, or may provide information sufficient to permit the controller 26 to determine that rate.

An operator or other user may provide input to the controller 26 using the operator controls 30 to specify the ratio of cement to aggregate and other admixtures for a particular type of concrete or job. This input may be saved and used for future similar jobs. While not shown in FIG. 1, the controller 26 may also be operably connected to control and receive feedback from a water dispenser and one or more admixture dispensers.

In operation, the system 10 is based on rate of decumulation, rather than on total weight or starting weight. The system 10 assures that the cement is dispensed at a constant rate per count (aka single full rotation of conveyor).

The conveyor monitor 28 senses the speed of the conveyor 22, which is conveying the aggregate to the mixer output 24, and sends a signal to the controller 26 that indicates the speed in rpms or counts per minute. The decumulating monitoring system 18 then senses the rate at which the cement is decumulating and signals that rate to the controller 26. The controller 26 then calculates the cement output per count, and adjusts the output control 16 accordingly. For example, if the controller 26 determines that, based on the rate of decumulation, the amount of cement being added per count to the aggregate is less than the desired amount, the controller 26 causes the cement output control 16 to increase the rate of dispensing, for example by increasing the rpms of the cement auger. If the controller 26 determines that the amount of cement per count is more than desired, the controller 26 causes the cement output control 16 to decrease the rate of dispensing cement. As a result, the system 10 maintains a consistent amount of cement per count even as condition change. This is highly desirable as amount of cement per count is an industry (and often required) standard for volumetrically mixed concrete.

The adjustment of rate of cement dispensing may be done periodically, for example every ten counts. The current rate of cement dispensing per count may be an average of the rate determined over the previous ten counts. The number of counts used to determine the current average may be a different number than ten. Adjustments in dispensing rates may be triggered only if the average rate of dispensing per count is outside a given range. The adjustments in dispensing rates may be by a uniform step up or down, or may be variable in size depending upon the size of variance from the desired amount of cement per count. If the variance from the desired amount is so great that it indicates a malfunction is occurring, or that the concrete will not be usable, the controller 26 can be programmed to immediately terminate the process by shutting down the cement dispensing apparatus 12 and the conveyor 22, in order to avoid wasting material.

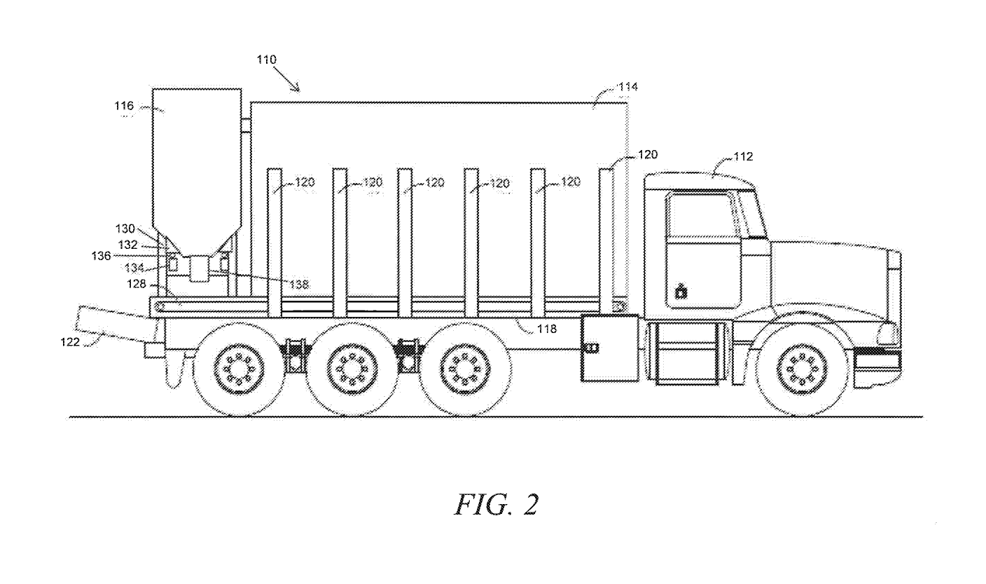

FIG. 2 shows a side elevation view of a mobile concrete mixing unit 110 according to one embodiment of the present invention. The mixing unit 110 is mounted on a truck 112. The truck 112 can be used to transport the mixing unit 10 to a desired location where the mixing unit 110 can be used to continuously mix and dispense a concrete mixture. The mixing unit 110 includes a large aggregate bin 114 and a relatively smaller cement bin 116 mounted on a supporting frame 118. The support frame 118 includes ribs 120 that extend upwardly and support the aggregate bin 14. In operation, aggregate from the aggregate bin 114 is mixed with dry cement from the cement bin 116 along with water, and in some cases additional admixtures, to form a concrete mixture that is dispensed through chute 122. The cement bin 116 is supported on the support frame 118 by cement bin supports 130. More particularly, load cells 136 are provided between the cement bin support 130 and the cement bin 116. In the embodiment shown, the cement bin supports each of a shoulder 134 on which the load cells 136 rest. The cement bin 116 is provided with a flange 132 that rests on the load cells 136. Preferably, the load cells 136 are structured and placed such that they can accurately measure the load between the bin 116 and the support 130. More particularly, it should be understood that the actual accuracy of the load cells 136 with respect to the absolute weight is not critical, provided the cells accurately measure changes in load.

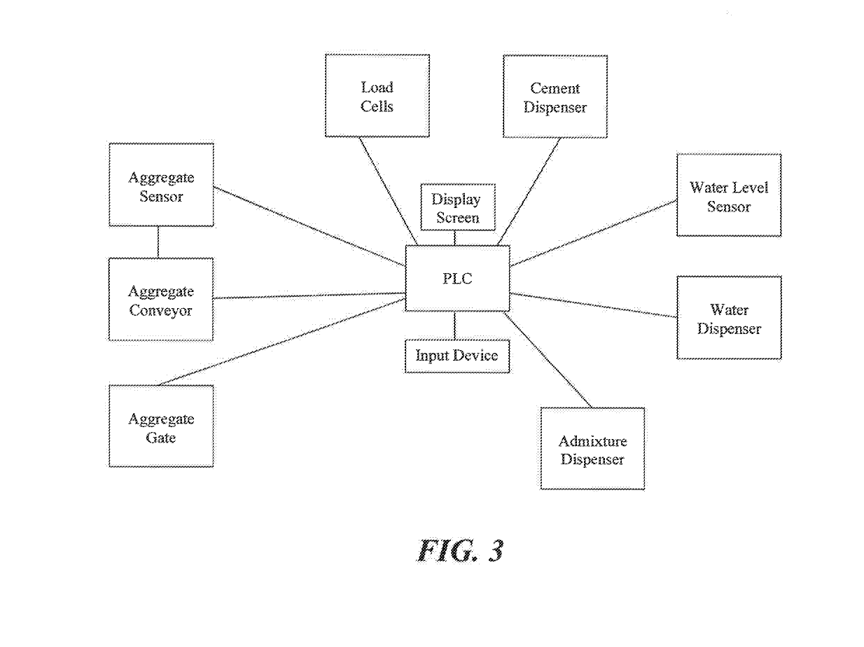

FIG. 3 is a schematic of the mobile concrete mixing unit 110 of FIG. 2. As seen in FIG. 3, the unit 110 includes a programmable logic controller (PLC) that acts as the controller. The PLC has an associated display screen and an input device that permits a user to interface with and control the system. The PLC controller is in communication with several elements in order to control the system 110 to provide concrete on a continuous volumetric basis that includes a consistent desired amount of cement per count of the aggregate conveyor throughout a mixing operation and from job to job. Specifically, an aggregate sensor senses the rate at which the aggregate conveyor is rotating and provides that information to the PLC controller. The PLC controller may also be used to set the rate at which the aggregate conveyor rotates. The PLC controller may also be used to set an aggregate gate height, which can vary the amount of aggregate provided per count. Load cells are used to measure the load between the cement bin and the frame. The load cells provide this information to the PLC controller, which the PLC controller uses to determine the rate at which the cement is decumulating per count of the aggregate conveyor. As discussed above, alternatives to the load cells may be used to determine the rate at which the cement is decumulating per count. For example rather than weight load, the system may sense another physical property that is a proxy for the rate at which the cement is decumulating. The PLC controller can adjust the cement dispenser to provide cement at a faster or slower rate, if the PLC controller determines that the rate of cement dispensed per count is varying from the desired amount. If the amount of cement being dispensed per count varies from the desired amount by too large of an error, the PLC controller may cause the entire process to terminate so avoid wasting materials. The display screen may provide an indication of how great the error is, as well as an indication of what may be causing the error.

The PLC controller may also be in communication with the water dispenser and one or more admixture dispensers to add water and admixture chemicals to the concrete mixture at the appropriate rates per count. The water dispenser and admixture dispenser preferably use positive displacement pumps to accurately dispense the water and admixture materials on a consistent rate per count. The rates of dispensing from the water dispenser and admixture dispensers can be set using the PLC controller.

The input device and display screen allow a user to select a pre-programmed mixture, or to create a new mixture for a job. The display screen can also provide information about a current mixing operation, for example the current rate of cement per count, the amounts of water and admixture per count, and the amount of cement, aggregate, and water remaining. The PLC controller may be connected to communication equipment (not shown) that allows the PLC controller to be programmed remotely, such that a desired formulation can be provided to a unit in the field from a central office. Furthermore, the PLC controller may communicate with a remote location to permit the remote location to monitor a mixing operation in the field as it is occurring. This monitoring can include geographical information so that a central unit may be aware of when and where a mixing operation is occurring. The information regarding the mixing operations can be saved and stored on an electronic storage medium for review at a later time.

A preferred embodiment of the present invention has been described above. It should be understood that modifications may be made in detail, especially matters of size, shape, and arrangement of parts. Such modifications are deemed to be within the scope of the present invention, which is to be limited only by the language of the claims, which are set forth below.

What is claimed is:

1. A volumetric concrete mixer comprising:
a support frame;
an aggregate bin supported by the support frame;
a conveyor below the aggregate bin for transporting aggregate to a mixing area;
an aggregate sensor for counting rotations of the conveyor;
a cement bin;
a cement dispenser for dispensing cement from the cement bin to the mixing area at a cement dispenser speed;
a cement decumulating monitoring system associated with the cement bin;
a water supply;
a water dispenser for dispensing water from the water supply to the mixing area;
a processor in communication to receive an input from the decumulating monitoring system and in communication to receive an input of a number of rotations of the conveyor from the aggregate sensor, the processor being adapted to determine a rate of change of weight of the cement bin over a set number of rotations of the conveyor, the processor further being adapted to instruct the cement dispenser to adjust the cement dispenser speed to maintain a constant rate of cement being dispensed from the dispenser bin to the mixing area per the set number of rotations of the conveyor.

2. The volumetric concrete mixer of claim 1, wherein the conveyor is a belt.

3. The volumetric concrete mixer of claim 1, wherein the decumulating monitoring system comprises a plurality of cement bin load cells provided between the support frame and the cement bin for measuring a weight of the cement bin.

4. The volumetric concrete mixer of claim 3, wherein the load cells will accurately measure change in weight of cement bin even when the mixer is not located on level ground.

5. The volumetric concrete mixer of claim 1, wherein the processor is adapted to stop operation of the conveyor, the cement dispenser, and the water dispenser when the rate of cement being dispensed is too far from the constant rate.

6. The volumetric mixer of claim 1, wherein the water dispenser is a positive displacement pump that includes an rpm monitor that signals an rpm rate to the processor, and further wherein the processor is in communication to control the positive displacement pump.

7. The volumetric mixer of claim 1, wherein the mixer further comprises an admixture storage bin and an admixture dispenser, and further wherein the processor is in communication to control the admixture dispenser.

8. The volumetric mixer of claim 7, wherein the processor is programmed with a plurality of mix recipes, and further wherein the processor can control the water dispenser, the conveyor, the cement dispenser, and the admixture dispenser to mix the water, aggregate, cement, and admixture in a ratio specified by a selected one of the plurality of mix recipes.

9. The volumetric mixer of claim 1, wherein the cement dispenser comprises a variable speed auger.

10. A method of dispensing concrete on a volumetric basis comprising:
providing a volumetric concrete mixer that includes:
a support frame;
an aggregate bin supported by the support frame;
a conveyor below the aggregate bin for transporting aggregate to a mixing area;
a cement bin;
a cement dispenser for dispensing cement from the cement bin to the mixing area, the cement dispenser including a dispensing element that moves at a controllable speed;
a water supply;
a water dispenser for dispensing water from the water supply to the mixing area; and a control processor;
conveying aggregate to the mixing area with the conveyor;
counting rotations of the aggregate conveyor and signaling a number of counted rotations to the control processor;
dispensing cement from the cement bin to the mixing area by running the dispensing element of the cement dispenser at an initial rate as instructed by the control processor;
dispensing water to the dispensing area;
periodically weighing the cement bin and signaling the weights to the control processor,
determining a rate of change of the weight of the cement bin based on the signaled weights using the control processor; and
using the control processor to automatically adjust the rate of the dispensing element of the cement dispenser from the initial rate to a subsequent rate to maintain a constant rate of cement being dispensed from the dispenser bin to the mixing area per the set number of rotations of the conveyor.

11. The method of claim 10, wherein the weighing step comprises using a plurality of load cells provided between the cement bin and the support frame.

12. The method of claim 11, wherein the load cells will accurately measure change in weight of cement bin even when the mixer is not located on level ground.

13. The method of claim 12, further comprising using the control processor to automatically stop operation of the conveyor, the cement dispenser, and the water dispenser when the control processor determines that the rate of cement being dispensed is too far from the constant rate.

14. The method of claim 10, wherein the water dispenser is a positive displacement pump that includes an rpm monitor that signals an rpm rate to the control processor, and further wherein the control processor is in communication to control the positive displacement pump.

15. The method of claim 10, wherein the volumetric concrete mixer further comprises an admixture storage bin and an admixture dispenser, and further wherein the control processor is in communication to control the admixture dispenser.

16. The method of claim 15, wherein the control processor is programmed with a plurality of mix recipes, and further wherein the control processor controls the water dispenser, the conveyor, the cement dispenser, and the admixture dispenser to mix the water, aggregate, cement, and admixture in a ratio specified by a selected one of the plurality of mix recipes.
